(19) United States
(12) Patent Application Publication
(10) Pub. No.: US 2026/0327006 A1
(43) Pub. Date: Oct. 22, 2026

(54) CENTERING AND SUPPORT INTERFACE, AND STORAGE RACK COMPRISING SUCH AN INTERFACE

(71) Applicant: EXOTEC PRODUCT FRANCE, CROIX (FR)

(72) Inventors: Benoît BOUCHEZ, CYSOING (FR); Sébastien CABOT, SARS ET ROSIERES (FR)

(73) Assignee: EXOTEC PRODUCT FRANCE, CROIX (FR)

(21) Appl. No.: 19/108,867

(22) PCT Filed: Sep. 5, 2023
(86) PCT No.: PCT/EP2023/074325

§ 371 Date: Mar. 5, 2025

(30) Foreign Application Priority Data
Sep. 14, 2022 (FR) 2209258

(51) Int. Cl. B65G 1/08; B65G 1/06

(52) U.S. Cl. CPC B65G 1/08; B65G 1/065

(57) ABSTRACT

A centering and support interface which is mechanical and includes an upper first bearing portion, configured to bear against an upper portion of a vertical face of an upright, a lower second bearing portion, configured to bear against a lower portion of the vertical face of the upright, a support portion, including an upper support face configured to ensure the supporting of the load, a connecting and centering portion, connecting the first bearing portion and the proximal end of the support portion, having an upper guiding face which ensures the centering of the load towards the support portion by the movement of the load due to gravity, a reinforcing portion, connecting the support portion and the second bearing portion.

### DESCRIPTION

This disclosure relates to a centering and support interface that is mechanical and is configured to be fixed so as to be laterally cantilevered from an upright of a storage rack in order to ensure the centering and support of a load on the storage rack.

The load may comprise a receptacle, and products or items contained in or on the receptacle. Typically, such a load may have a mass that is less than or equal to 100 kg per receptacle, in particular per bin. The load may further comprise a receptacle, such as a palette, supporting products or items. Such a load may then be much greater than 100 kg, and weigh for example up to 1 ton or more.

Receptacle is understood to mean any type of container or support that is capable of receiving and storing products or items, in particular such as a bin, a tray, or a container, of any type and shape, without this list being exhaustive.

This disclosure further relates to a storage rack comprising:
a vertical structure, comprising a set of vertical uprights,
typically, a spacer system comprising one or typically several spacer devices distributed along the height of the vertical structure, the or each spacer device mechanically interconnecting the uprights, and, notably:
one or more pairs of mechanical interfaces according to this disclosure.

The or each pair comprises a first interface and a second interface which are cantilevered relative to the uprights. Support portions of the first interface and second interface are oriented towards each other, configured to ensure:
the centering of a load inserted and deposited between the first interface and the second interface by the effect of the connecting and centering portions of the two interfaces, forming inclined ramps, then
the supporting of the load supported by the two support portions of the two interfaces, respectively on both sides of the load.

This disclosure further relates to a storage system comprising a storage rack according to this disclosure, and one or more receptacles configured to be supported in the storage rack, the or each receptacle being supported by support portions of the interfaces of a pair of interfaces.

This disclosure finds particular applications in the field of storage systems comprising at least one storage rack equipped with at least one interface according to this disclosure, at least one receptacle capable of being stored on said rack, and a transport system comprising at least one automated guided vehicle, the transport system being capable of grasping and depositing said receptacle in said rack.

### Technical Field

This disclosure falls within the field of warehouses which comprise storage racks. A storage rack conventionally comprises a vertical structure formed by a set of vertical uprights, often in the form of vertical metal sections.

Spacer devices, such as crosspieces or similar devices, connect the uprights. These spacer devices are distributed along the height of the vertical structure and ensure the stability of the storage rack. The spacer devices leave a plurality of storage spaces free between them along the height of the storage rack, which are configured to support loads stacked to different height levels in the rack, between the rack uprights.

To this end, pairs of mechanical interfaces are secured to the uprights, in order to ensure the centering and support of the various loads in the various storage spaces.

Throughout the present Application, “mechanical interface” specifically designates the mechanical connection device in the context of this disclosure, while the term “bracket(s)” more generally designates mechanical connection devices within the framework of the prior art.

### Prior Art

In the prior art known to the present Applicant, the mechanical connection devices connecting the rack to the load are generally in the form of brackets, which conventionally each comprise a cross-section having three portions, namely:
an upper bearing portion, configured to bear flatly against two coplanar side faces of two uprights, ensuring the attachment of the bracket by attachment members, often rivets,
a support portion which extends substantially cantilevered from the uprights, typically horizontally or close to horizontally, and therefore substantially perpendicular to the first bearing portion, the support portion ending in a free edge,
a connecting and centering portion which connects the bearing portion and the support portion, this connecting portion comprising a guiding face inclined towards the support portion.

The brackets each extend longitudinally in a horizontal direction X and vertically in a vertical direction Z. The aforementioned cross-section in three portions is determined in a plane parallel to YZ. The inclined guiding face forms a ramp configured to ensure the centering of a load due to gravity, in particular when the load is offset in the horizontal direction Y during its unloading.

Such brackets according to such prior art are conventionally obtained as one piece by preforming, typically by roll forming techniques on metal sheets, to form the three portions of the bracket.

This geometry in three portions (bearing portion, support portion, and connecting portion) is systematic in the field of storage systems comprising racks and served by a transport system comprising automated guided vehicles, the system being able to grasp and deposit items in said racks. Such storage systems bear the acronym ASRS, for “Automated Storage and Retrieval System”.

Such storage systems are disclosed in particular by document WO 2019/072432 filed by the present Applicant.

As can be seen in the figures of document WO 2019/072432, each bracket is formed as one piece by a preformed metal sheet, its cross-section consisting of the three aforementioned portions, respectively used for attaching the bracket, centering the load, and lastly supporting the centered load.

As disclosed by document WO2019/072432, automated guided vehicles are configured to remove receptacles of products or items supported by brackets in storage racks, and to transport them to another location, typically to another storage location or to an order preparation station where said items are intended to be gathered in order to assemble an order for an end customer.

To this end, the automated guided vehicles may comprise robots having means of locomotion and guidance in the warehouse. These robots can move longitudinally in an aisle separating two racks, namely “shelf” robots capable of moving across the warehouse floor and capable of carrying significant loads, or, in a preferred manner, robots capable of moving across the floor but also having mechanical means for climbing which allow them to move vertically on the racks as well.

In this last configuration, said robots may have a chassis equipped with climbing means. Typically, at least two motorized cogwheels are configured to mesh with the links of a substantially taut roller chain, or with the teeth of a toothed rack extending along an upright of said shelving. The cogwheels typically may have axes that are substantially orthogonal to the axes of the driving wheels of said trolley.

As disclosed by WO 2019/072432, the trolley of the automated guided vehicle further has a gripping device comprising a support that is movable relative to the chassis, configured to move from a retracted loading position for holding a bin on the chassis of the vehicle, in which the support is typically accommodated on the chassis, and to a deployed unloading position in which the movable support extends cantilevered from the chassis in order to unload/set down the bin, typically on one of the pairs of brackets of the storage rack.

Thus, autonomous robots may also have locomotion and orientation means, enabling them to move in three dimensions. In addition to the two planar dimensions generally associated with the floor on which the robots move, there is a vertical third dimension associated with the racks on which the robots are capable of climbing up and down. In this configuration, said robots have locomotion and climbing means, enabling them to move vertically by climbing up and down the warehouse racks. Examples of this technology appear, for example, in document WO 2018/189110, but also in WO 2020/056175, EP 3 288 865, and WO 2022/089811.

The present disclosure is in no way limited to the storage system comprising this type of automated vehicles moving in three dimensions.

Thus, from the point of view of the movement of said automated guided vehicles, their paths may be in only two dimensions, meaning in a plane. For this purpose, said autonomous vehicles have locomotion and orientation means capable of enabling such movements in these two dimensions. The floor of the warehouse, or more generally of the storage and retrieval system, may constitute the plane on which said autonomous vehicles move. One example that illustrates this technology is accessible in patent application WO 2007/149712. According to another known configuration, the racks arranged in the warehouse define a flat surface at their top on which autonomous vehicles may also move about. For example, patent application WO 2015/104263 illustrates this technology.

The present Applicant operates such storage and transport systems and more particularly those which comprise automated vehicles moving in three dimensions.

As a non-limiting indication, the receptacles may be bins having a bottom wall and four side walls, and typically having dimensions of 650 mm×450 mm (length by width). The bin may have different heights. The length (650 mm) typically extends parallel to the longitudinal direction X of the brackets, namely in a depthwise direction of the storage rack, parallel to the direction of insertion or extraction during loading or unloading operations.

A pair of brackets may be sized to support a single bin. Each bracket of the pair then typically has a length slightly greater than the length of the bin (650mm). A pair of brackets may also be sized to support two bins side by side, in two positions which are offset along the length of the brackets. Each bracket is then typically sized to have a length that is slightly more than twice the length of the bin (650 mm×2 which is 1300 mm).

Such storage and transport systems (including automated guided vehicles) are typically configured to support “light” loads, namely 30-40 kg per bin, typically 34 kg under operating conditions.

A pair of brackets for supporting a single bin must be able to support a load of 34 kg as well as the repetitive loading/unloading operations associated with this load, while a pair of brackets for supporting two bins, one next to the other, must be able to withstand a double load of 68 kg as well as the repetitive loading/unloading operations associated with this load.

Such storage and transport systems, in particular storage racks loaded with such bins, must further be able to support the load under safety buffer conditions, taking into account a possible increase in mass by the products contained in the bins, when a fire suppression system sprays water on the storage racks supporting the bins filled with products. Under safety buffer conditions, it is typically considered that the bin and the products soaked with water (contained in the bin) can reach a load of 100 kg. Such an increase in mass is observable in particular when the products or items contained in the receptacle have packaging of a water-retaining material, typically cardboard or an analogous material capable of absorbing a large amount of water.

A pair of brackets for supporting a single bin must be able to support a load of 100 kg, while a pair of brackets for supporting two bins, one next to the other on the bracket, must be able to withstand a load of 200 kg, under safety buffer conditions.

It is thus customary to design the sheets forming the brackets to be sufficiently thick to obtain a bracket robustness that satisfies such specifications:
not only under operating conditions, to avoid degradations/deformations of the bracket during use, typically fatigue under the repeated stresses during operations of loading and unloading the load (i.e. bins filled with products), typically by robots, on the brackets of the rack, but also
under safety buffer conditions, in order to take into account an increase in mass, particularly due to spraying water.

According to the aforementioned bracket design of the prior art (cross-section consisting of three portions), it is thus common to provide sheet metal (typically steel) having a thickness of around 2 mm (or more) in order to satisfy such specifications. Such a thickness satisfying such specifications results in a bracket having a linear density that is greater than or equal to 1.8 kg/m, typically between 1.8 kg/m and 2.4 kg/m, in the longitudinal direction X of the bracket. According to the observations of the inventors, these brackets can represent almost half the weight of the storage rack (i.e. comprising the vertical structure with the vertical uprights, the spacer devices, and said brackets).

In general, there has always been a need to reduce the amount of metal used in the manufacture of storage racks, the aim being financial savings as well as a reduction in the inherent environmental impacts.

However, known from document DE 10 2016 120 869 is a mechanical and support interface formed by a one-piece body, obtained by roll forming a metal sheet until a tubular metal section is obtained, which makes it possible to achieve improved performance in terms of rigidity and in particular with a “triangular hollow” metal section. In particular, in order to obtain the hollow metal section, the roll forming process provides for connecting the two ends of the metal sheet, respectively composed of the first edge of the sheet and the opposite U-shaped second edge which surrounds the first edge and closes off the hollow metal section. The two connected ends form a projection towards the rear of the interface, perpendicular to a support portion, this projection configured to penetrate a notch made in an upright.

DE 10 2016 120 869 thus discloses a support and centering interface which comprises, delimited by folding/bending lines that are parallel with each other:
an inclined connecting and centering portion,
a support portion,
a reinforcing portion,
a (single) bearing portion configured to bear in a continuous manner against a vertical face of the upright along the height of the upright.

According to the inventors' findings, the length of the unfolded sheet of such an interface based on a metal section having a closed section is significant.

Also known, from document ES 1 073 137 U, is an interface comprising:
a one-piece body, obtained by folding a metal sheet and shaping a first portion, a connecting and centering portion, a support portion, and a reinforcing portion, ending in a second portion, the different portions delimited by folding/bending lines,
two support flanges, ensuring the attachment of the body to two uprights of a shelving.

Also known, from document CH 551 327 (A), is a support interface formed by a metal section from sheet metal (or metal sheets) which has a closed cross-section, except at the base which has a continuous slit between two edges that is intended to engage with an attachment element. Thus, the preformed sheet/roll-formed sheet defines, delimited by folding/bending lines which are parallel to each other, a centering portion, a support portion, and a reinforcing portion.

According to the inventors' observations, in both documents ES 1 073 137 U and CH 551 327 (A), the preformed sheet defining the support, centering, and reinforcing portions and forming the one-piece body cannot be fixed directly to the surface of the uprights, but only by means of specific attachments of the interface, namely the support flanges of ES 1 073 137 U, or the attachment elements of CH 551 327.

### SUMMARY

This disclosure significantly improves this situation.

According to a first aspect, a centering and support interface is proposed which is mechanical and is configured to be fixed so as be laterally cantilevered from an upright of a rack in order to ensure the centering and supporting of a load on the rack, the upright extending in a vertical direction Z1, said interface comprising:
an upper first bearing portion, configured to bear against an upper portion of a vertical face of the upright, intended to ensure the attachment of the interface to the upright,
a lower second bearing portion, configured to bear against a lower portion of the vertical face of the upright,
a support portion, comprising an upper support face configured to ensure the supporting of the load, the support portion extending from a proximal end to a distal end while increasing the distance from the first bearing portion and the second bearing portion,
a connecting and centering portion, connecting the first bearing portion and the proximal end of the support portion, having an upper guiding face ensuring the centering of the load towards the support portion by the movement of the load due to gravity,
a reinforcing portion, connecting the distal end of the support portion and the second bearing portion to form a reinforcing leg.

The features set forth in the following paragraphs may optionally be implemented. They may be implemented independently of one another or in combination with one another:

According to one embodiment, said interface is made of metal, typically steel, and said interface has a linear density in the lengthwise direction X1 that is less than or equal to 1.5 kg/m, in particular is between 0.8 kg/m and 1.3 kg/m.

According to one embodiment, said interface comprises a body made as one piece, formed by a preformed metal sheet extending continuously so as to form successively, from top to bottom along the direction of the upright:
the first bearing portion,
the connecting and centering portion,
the support portion,
the reinforcing portion, and
the second bearing portion.

The first bearing portion, the connecting and centering portion, the support portion, the reinforcing portion, and the second bearing portion are respectively delimited by folding/bending lines in the metal sheet which are parallel to each other, oriented in the longitudinal direction of the interface, comprising:
a first folding/bending line between the first bearing portion and the connecting and centering portion,
a second folding/bending line between the connecting and centering portion and the support portion,
a third folding/bending line between the support portion and the reinforcing portion,
a fourth folding/bending line between the reinforcing portion and the second bearing portion.

According to one embodiment, the thickness of the metal sheet is less than or equal to 1.5 mm, typically between 0.5 mm and 1.5 mm. In particular, the thickness of the metal sheet is less than or equal to 1 mm, more particularly between 0.5 mm and 1 mm.

According to one embodiment, the unfolded length of the sheet in a cross-section perpendicular to the folding/bending lines is between 170 mm and 210 mm.

According to one embodiment, the first bearing portion and/or the second bearing portion comprises/comprise several attachment tabs configured to ensure the attachment of a metal section forming an upright having attachment openings, by insertion of the attachment tab or tabs into one or more of the attachment openings of the metal section.

According to one embodiment, at least one of the tabs, oriented downwards, is configured to hook into an attachment opening and is provided with a lift-prevention device comprising an elastic tooth configured to come into abutment abut against an upper edge of the attachment opening, opposing an unhooking of the attachment tab.

According to one embodiment, the first bearing portion and/or the second bearing portion comprises openings for attachment members such as rivets.

According to one embodiment, the first bearing portion is double-skinned, obtained by folding the metal sheet onto itself, the attachment openings traversing the two skins.

According to one embodiment, the first bearing portion and the second bearing portion are coplanar, extending in a plane X1Z1 that is parallel to the vertical face of the upright which the first bearing portion and second bearing portion rest against at two positions on the upright which are offset along the vertical direction Z1 of the upright.

According to one embodiment, the connecting and centering portion extends from the first bearing portion to the proximal end of the support portion, in a direction that is inclined relative to the vertical direction Z1 at an angle A1 of between 25° and 45°, such as 33°, ensuring a downward inclination of the guiding face towards the support portion.

According to one embodiment, the connecting and centering portion extends from the first bearing portion to the proximal end of the support portion, in a direction that is inclined relative to a horizontal direction Y1 at an angle A10 of between 45° and 65°, direction Y1 being perpendicular to the first bearing portion and to the second bearing portion.

According to one embodiment, the support portion extends from the proximal end to its distal end in a downward incline relative to a horizontal direction Y1 at a non-zero angle A2 of between 0° and 5°, direction Y1 being perpendicular to the first bearing portion and to the second bearing portion

According to one embodiment, the reinforcing portion extends from the distal end of the support portion to the second bearing portion while drawing closer to the second bearing portion, and in a downward incline relative to a horizontal direction Y1 at an angle A3 of between 5° and 30°, direction Y1 being perpendicular to the first bearing portion and to the second bearing portion.

According to one embodiment, said interface extends lengthwise in a horizontal direction X1 that is parallel to the first bearing portion and to the second bearing portion, comprising, along direction X1:
an open first end, configured to allow the insertion or extraction of a load by a movement of the load along direction X1,
a closed second end, comprising stopping means which protrude upwards from the connecting and centering portion and/or from the support portion and which are configured to stop the load during its insertion along direction X1.

According to one embodiment, the stopping means comprise:
a first stop, formed by a tab of the metal sheet, protruding from the connecting and centering portion via a folding/bending line between the first stop and the connecting and centering portion,
a second stop, formed by a tab of the metal sheet, protruding from the support portion via a folding/bending line extending between the second stop and the portion. Advantageously, the tab forming the first stop and the tab forming the second stop have two overlapping portions of the tabs which are secured to each other by at least one connection point securing the tabs to each other, typically obtained by welding, clinking (press-joining), or stapling.

According to one embodiment, said interface may consist of said body made as one piece, formed by a preformed metal sheet.

According to one embodiment, said interface may, in a cross-section viewed in a plane parallel to plane Y1Z1, consist of the following five portions:
the first bearing portion,
the connecting and centering portion,
the support portion,
the reinforcing portion, and
the second bearing portion.

According to one embodiment, the second bearing portion extends between the fourth folding/bending line and a lower free edge of the preformed metal sheet.

According to one embodiment, the first bearing portion extends between the first folding/bending line and an upper free edge of the preformed metal sheet.

According to one embodiment, the first bearing portion and the second bearing portion extend outwards from the first folding line and from the fourth folding line respectively, in two opposite directions.

According to one embodiment, the cross-section of the preformed metal sheet, in a plane perpendicular to the direction of the folding/bending lines, is an open cross-section.

According to a second aspect, this disclosure relates to a storage rack comprising:
a vertical structure comprising a set of vertical uprights,
a spacer system comprising one or more spacer devices distributed along the height of the vertical structure, mechanically interconnecting the uprights,
one or more pairs of interfaces according to this disclosure, the pair of interfaces or each pair of interfaces comprising:
   a first interface fixed by the first bearing portion and second bearing portion to at least two uprights of the vertical structure,
   a second interface fixed by the first bearing portion and second bearing portion to at least two other uprights of the vertical structure,
      and wherein the support portions and the connecting and centering portions respectively belonging to the first interface and to the second interface are oriented towards each other and are configured to ensure: the centering of a load inserted and deposited between the first Interface and the second interface by the effect of the connecting and centering portions of the two interfaces, and the supporting of a load supported by the two support portions of the two interfaces on both sides of the load.

According to a third aspect, this disclosure relates to a storage system for a warehouse, comprising receptacles and at least one storage rack according to this disclosure comprising several pairs of interfaces distributed along the height of the storage rack, each receptacle configured to be supported on both sides of the receptacle simultaneously and respectively by the support portion of the first interface and by the support portion of the second interface. The storage system may have a transport system comprising at least one automated guided vehicle, said transport system being configured for grasping and depositing receptacles in storage racks.

According to one embodiment of the storage system, the vertical structure of the storage rack, in particular at least one of the uprights, comprises a toothed rack extending along the height of the vertical structure, or a taut chain extending along the height of the vertical structure. Said at least one automated guided vehicle has a chassis, carrying a mechanism for traveling across a horizontal surface such as a floor, and climbing means comprising at least one cogwheel configured to mesh with the toothed rack or with the links of the taut chain so as to enable the automated guided vehicle to climb up and down the vertical structure of the storage rack.

Said at least one automated guided vehicle may comprise a deployable loading/unloading system configured for:
loading a receptacle from a retracted first position above the chassis to a deployed second position where the receptacle is centered and then supported by resting simultaneously on the first interface and second interface, or
extracting a receptacle from the second position resting on the first interface and second interface of a pair of interfaces and loading it into the first retracted position.

This disclosure finds particular applications for a load comprising one or more receptacles held by a pair of mechanical interfaces supporting the receptacle or receptacles, for up to 100 kg per supported receptacle.

### BRIEF DESCRIPTION OF DRAWINGS

Other features, details and advantages will become apparent upon reading the detailed description below, and upon analyzing the attached drawings, in which:

FIG. 1A is a schematic front view of a storage rack according to this disclosure, comprising a pair of mechanical interfaces according to this disclosure, comprising a first interface and a second interface which are mechanical and which are oriented towards each other and are configured to ensure the guiding and supporting of a load such as a receptacle (empty or filled with product(s)).

FIG. 1B is a top view of the storage rack of FIG. 1a.

FIG. 2A is a view of one embodiment of a mechanical interface according to this disclosure, obtained from a metal sheet 0.6 mm thick (plus or minus 0.05 mm), comprising, from top to bottom:
the first bearing portion, notably double-skinned,
the connecting and centering portion,
the support portion,
the reinforcing portion,
the second bearing portion.

FIG. 2B is a detailed view of FIG. 2a, illustrating the first bearing portion, obtained by folding the sheet onto itself so as to form a double skin, the first bearing portion comprising openings through the two skins, for attachment by rivet(s).

FIG. 3A is a view of one embodiment of a mechanical interface according to this disclosure, obtained from a metal sheet 0.8 mm thick (plus or minus 0.05 mm), comprising, from top to bottom:
the first bearing portion, with one skin
the connecting and centering portion,
the support portion,
the reinforcing portion,
the second bearing portion.

FIG. 3B is a detailed view of FIG. 3a, illustrating the first bearing portion having one skin, the first bearing portion comprising openings for attachment by rivet(s).

FIG. 4 is a perspective view of a mechanical interface according to a third embodiment, comprising the first bearing portion and the second bearing portion which notably comprise, respectively, a first attachment tab configured to be inserted in an first upper opening of an upright metal section and a second attachment tab configured to be inserted in a lower second opening, the first bearing portion notably provided with an elastic tooth of a lift-prevention device which engages with an upper edge of the first opening so as to prevent an untimely detachment from the first attachment tab.

FIG. 5A is a perspective view of an interface (straight) according to a first embodiment, of 1315 mm in length, configured to support two receptacles, in particular two bins (650 mm×450 mm), along the length of the interface.

FIG. 5B is a detailed view illustrating the securing at a clinching point (or a welding point) between a folded tab of a first stop extending the connecting and centering portion, and a folded tab of a second stop extending the support portion.

FIG. 6A is a perspective view of an interface (straight), of a length configured to support two receptacles, in particular two bins (650 mm×450 mm), along the length of the interface.

FIG. 6B is a detailed view illustrating a folded tab of a first stop extending the connecting and centering portion, and a folded tab of a second stop extending the support portion, the first stop and the second stop overlapping.

FIG. 7A is a perspective view of an interface (straight) according to a third embodiment, 657 mm in length, configured to support a single receptacle, in particular a single bin (650 mm×450 mm), along the length of the interface.

FIG. 7B is a detailed view illustrating a folded tab of a first stop extending the connecting and centering portion, and a folded tab of a second stop extending the support portion, the first stop and the second stop partially overlapping.

### DESCRIPTION OF EMBODIMENTS

The drawings and the description below for the most part contain elements that are certain in nature. They will therefore not only serve to provide a better understanding of this disclosure, but where appropriate may also contribute to its definition.

Thus, this disclosure relates to a centering and support interface 1 that is mechanical and is configured to be fixed so as to be laterally cantilevered from an upright M1, M2, M3, M4 of a rack in order to ensure the centering and support of a load W on the rack, the upright extending in a vertical direction Z1.

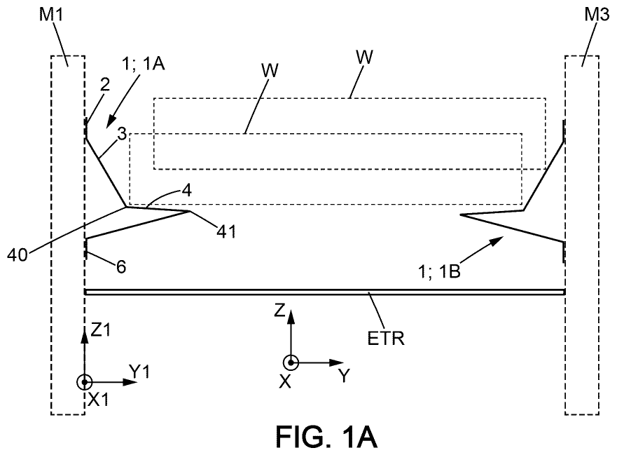

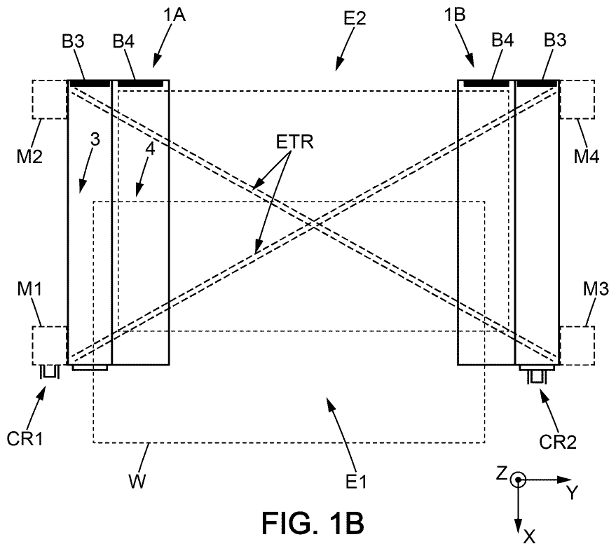

In FIG. 1a, and in general, the horizontal direction X1 extends in a longitudinal direction of mechanical interface 1, and the horizontal direction Y1 extends in a direction orthogonal to direction X1.

In FIG. 1a, a pair of two interfaces 1 is represented, each interface 1 comprising:
an upper first bearing portion 2, configured to bear against an upper portion of a vertical face of the upright, intended to ensure the attachment of the interface to the upright,
a lower second bearing portion 6, configured to bear against a lower portion of the vertical face of the upright.

First bearing portion 2 is fixed to the upright(s), typically by attachment members such as rivets, or by attachment tabs described below. Second bearing portion 6 is not necessarily fixed to the upright(s), and may simply rest against the uprights. The second bearing portion may however be fixed to the upright(s), typically by attachment members such as rivets, or by attachment tabs.

Each interface 1 may typically be fixed to a pair of uprights, namely a first upright M1 (or M3) and second upright M2 (or M4), in positions that are offset in a lengthwise direction along interface 1. Interface may be coupled to the two uprights, at the respective longitudinal ends of mechanical interface 1.

First bearing portion 2, the upper portion, intended to ensure the attachment of the interface to the upright, is then configured to bear simultaneously against both uprights, on an upper portion of a vertical face of first upright M1 (or M3) and on an upper portion of a vertical face of second upright M2 (or M4).

Second bearing portion 6, the lower portion, is configured to bear simultaneously against the two uprights (M1 and M2 or M3 and M4), on a lower portion of the vertical face of first upright M1 (respectively M3) and on a lower portion of the vertical face of second upright M2 (resp. M4).

According to one embodiment, first bearing portion 2 and second bearing portion 6 may be coplanar, extending in a plane X1Z1 that is parallel to the vertical face of upright(s) M1 (or M2), M3 (or M4) which first bearing portion 2 and second bearing portion 6 rest against at two positions on the upright (in particular first upright M1 or second upright M2) which are offset along vertical direction Z1 of upright M1, M2.

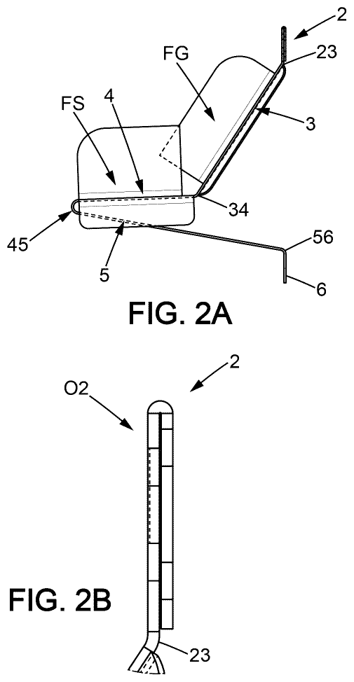

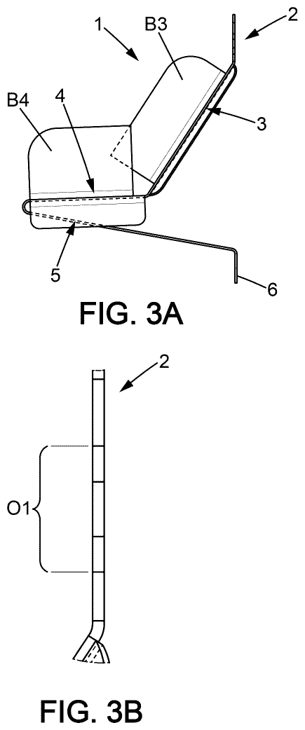

The height of the mechanical interface, which may extend between first bearing portion 2 and second bearing portion 6, is typically between 7 cm and 11 cm, in particular between 8 cm and 10 cm, and for example is 89.2 mm (FIG. 2A) or 93.3 mm (FIG. 3A).

Such an interface further comprises a support portion 4, comprising an upper support face FS configured to ensure the supporting of load W. Support portion 4 extends from a proximal end 40 to a distal end 4 while distancing from first bearing portion 2 and second bearing portion 6.

Support portion 4 may extend from proximal end 40 to distal end 41 in a downward incline relative to a horizontal direction Y1, at an angle A2 that is strictly greater than 0°, typically between 0° and 5°, in particular between 1° and 3°, such as 2°. The choice of a non-zero angle is of particular interest for centering the load to be stored on the rack. Direction Y1 is perpendicular to first bearing portion 2 and to second bearing portion 6. The length of support portion 4 from proximal end 40 to distal end 41 may be between 2 cm and 6 cm, in particular between 3 cm and 5 cm, such as 4 cm.

Interface 1 further presents a connecting and centering portion 3, connecting first bearing portion 2 and proximal end 40 of support portion 4. Connecting and centering portion 3 has an upper guiding face FG which ensures the centering of the load towards support portion 4 via the movement of the load due to gravity.

To this end, connecting and centering portion 3 may extend from first bearing portion 2 to proximal end 40 of support portion 4, in a direction that is inclined relative to vertical direction Z1 at an angle that is typically between 25° and 45°, such as 33°, ensuring a downward inclination of guiding face FG towards support portion 4.

In particular, connecting and centering portion 3 may extend from first bearing portion 2 to proximal end 40 of support portion 4, in a direction that is inclined relative to a horizontal direction Y1 at an angle A10 of between 45° and 65°, direction Y1 being perpendicular to first bearing portion 2 and to second bearing portion 6. The size of connecting and centering portion 3 in direction Y1 may be between 25 mm and 60 mm, such as 32.1 mm in FIG. 2A, or 55 mm in one non-illustrated example.

In all cases, angle of inclination A10 between connecting and centering portion 3 and horizontal direction Y1 is greater than angle of inclination A2 between support portion 4 and horizontal direction Y1 which may be zero or, preferably, non-zero.

During unloading operations, in the event of poor centering, guiding face FG cooperates with load W so as to move it along direction Y1, moving it away from the uprights connected with first bearing portion 2 and second bearing portion 6.

Notably, a reinforcing portion 5 connects distal end 41 of support portion 4 and second bearing portion 6 to form a reinforcing leg. The size of said interface in direction Y1 may be between 50 mm and 90 mm, in particular between 60 mm and 80 mm, such as 74.5 mm in FIGS. 2A and 3A. This size is measured between, on the one hand, distal end 41 of the support portion, even the zone where reinforcing portion 5 and distal end 41 are joined, and on the other hand, the plane passing through first bearing portion 2 and second bearing portion 6.

Reinforcing portion 5 may extend from distal end 41 of support portion 4 to second bearing portion 6 while drawing closer to second bearing portion 6, and in a downward incline relative to a horizontal direction y1 at an angle A3 of between 5° and 30°, in particular when direction Y1 is perpendicular to first bearing portion 2 and to second bearing portion 3.

In general, the mechanical interface comprises or consists of five portions, and, in a section view in a plane parallel to plane Y1Z1:
first bearing portion 2,
connecting and centering portion 3,
support portion 4,
reinforcing portion 5, and
second bearing portion 6.

Such a design for an interface 1 with five portions according to this disclosure makes it possible to significantly reduce the mass of the mechanical interface with a view to compliance with defined specifications relating in particular to a maximum mass of the load under operating and/or safety buffer conditions, and in comparison to a design with three portions as in the brackets of the prior art.

For example, with regard to the application of mechanical interfaces for the supporting of receptacles, in particular such as bins (650 mm×450 mm), and in order to comply with the aforementioned conditions, namely 34 kg maximum under operating conditions and 100 kg maximum under safety buffer conditions: for 100 kg, it is advantageously possible to obtain a linear density in a direction X1 along the length of the interface that is less than or equal to 1.5 kg/m, in particular between 0.8 kg/m and 1.3 kg/m.

These linear density values are to be compared with the linear density of the brackets according to the prior art, which must be greater than or equal to 1.8 kg/m, very often between 1.8 kg/m and 2.4 kg/m along longitudinal direction X of the bracket in order to satisfy these same specifications. This is considerable progress, as the mass of the interface according to this disclosure may advantageously be twice as light as the brackets according to the prior art, for the same effect and for the same material of the interface/bracket, typically metal, typically steel, in particular a galvanized steel for which the density is between 7 and 8, typically 7.8.

Mechanical interface 1 may comprise (or consist of) a body made as one piece formed by a preformed metal sheet extending continuously so as to form successively, typically, in cross-section (in a plane parallel to plane Y1Z1), typically from top to bottom along the direction of upright M1; M2; M3; M4:
first bearing portion 2,
connecting and centering portion 3,
support portion 4,
reinforcing portion 5, and
second bearing portion 6.

Also:
first bearing portion 2 and second bearing portion 6 respectively extend outwards from first folding line 23 and from fourth folding line 56 in two opposite directions, namely in an upwards direction from first folding line 23, for first bearing portion 2, and in a downwards direction from fourth folding line 56, for second bearing portion,
the cross-section of the preformed metal sheet, in a plane perpendicular to the direction of the folding/bending lines, is an open cross-section.

In general, and in particular as illustrated by the examples in the figures, first bearing portion 2, connecting and centering portion 3, support portion 4, reinforcing portion 5, and second bearing portion 6 are respectively delimited by the mutually parallel folding/bending lines 23, 34, 45, 56 of the metal sheet (typically steel, in particular galvanized steel), which are oriented along longitudinal direction X1 of the interface, comprising:
a first folding/bending line 23 between first bearing portion 2 and connecting and centering portion 3,
a second folding/bending line 34 between connecting and centering portion 3 and support portion 4,
a third folding/bending line 45 between support portion 4 and reinforcing portion 5,
a fourth folding/bending line 56 between reinforcing portion 5 and second bearing portion 6.

Said mechanical interface according to this disclosure, in particular the formation of folding/bending lines 23, 34, 45, 56, may typically be obtained by cold roll forming techniques, and in particular at lower cost.

The metal sheet may have a thickness of less than or equal to 1.5 mm, typically between 0.5 mm and 1.5 mm. In particular, the thickness of the metal sheet is less than or equal to 1 mm, more particularly between 0.5 mm and 1 mm. FIGS. 2A and 2B illustrate one embodiment of the mechanical interface having a thickness of 0.6 mm plus or minus 0.05 mm. FIGS. 3A and 3B illustrate another embodiment of the mechanical interface having a thickness of 0.8 mm plus or minus 0.05 mm. These two examples in FIGS. 2A, 2B and 3A, AB both allow satisfying the aforementioned specifications (support for receptacles such as 650 mm×450 mm bins, maximum 34 kg per bin under operating conditions, and maximum 100 kg per bin under safety buffer conditions).

These thickness values are to be compared to a minimum thickness of 2 mm for brackets of the prior art, while satisfying the same specifications. Thus and as an example, the thickness value of 0.8 mm according to this disclosure in FIGS. 3a and 3b, is reduced by a ratio equal to 2.5 in comparison to the prior art which has a thickness value of 2 mm.

It is notable that according to this disclosure, the unfolded length of the sheet in a cross-section perpendicular to folding/bending lines 23, 34, 45, 56 may typically be between 170 mm and 210 mm. Such a value range is to be compared with the unfolded length of the sheet of a bracket according to the prior art in a cross-section perpendicular to the folding/bending lines which is indeed lower, but only by a ratio of 1.5.

As is understandable, the gain in terms of decreased thickness according to the design in this disclosure (typically 2.5) is, as a ratio, much higher than the ratio (typically 1.5) of the increase in the unfolded length of the sheet. Consequently, the advantageously desired loss of mass due to the reduction in thickness according to this disclosure largely surpasses the unwanted gain in mass due to the increase in the unfolded length, which advantageously allows achieving a decrease in mass, and for example a linear density of 0.8 kg/m to 1.3 kg/m according to this disclosure, to be compared to a range of between 1.8 kg/m and 2.4 kg/m in the prior art while still in compliance with the specifications set forth above.

In general, first bearing portion 2 and/or second bearing portion 6 may typically be fixed to upright M1, M2, M3, M4, or even to other beams of the rack, by means of attachment members such as rivets. To this end, first bearing portion 2 and/or second bearing portion 6 comprises openings O2 for attachment members such as rivets.

According to one embodiment, first bearing portion 2 may be double-skinned, obtained by folding the metal sheet onto itself, with attachment openings 02 traversing the two skins. Such an embodiment allows strengthening the first bearing portion, in particular against the risk of the sheet deforming/tearing at the area of contact between the interface and the attachment members. Such an embodiment is illustrated for indicative purposes in FIG. 2B, where the thickness of the metal sheet is only 0.6 mm, while still in compliance with the aforementioned specifications. Such an embodiment finds particular applications when there is a risk of the single-skinned first bearing portion deforming/tearing at the attachment.

According to one or more embodiments, and in particular as illustrated in the figures, second bearing portion 6 may extend between fourth folding/bending line 56 to a lower free edge of the preformed metal sheet.

According to one embodiment, first bearing portion 2 extends between first folding/bending line 23 to an upper free edge of the preformed metal sheet.

According to one embodiment, mechanical interface 1 extends lengthwise along a horizontal direction X1 that is parallel to first bearing portion 2 and to second bearing portion 6, interface 1 possibly comprising, along longitudinal direction X1:
an open first end E1, configured to allow the insertion or extraction of a load by moving the load along direction X1, in particular by sliding the load on the connecting and centering portion and/or by sliding the load on the support portion,
a closed second end E2, comprising stopping means B3, B4, protruding upwardly from connecting and centering portion 3 and/or from support portion 4, configured to ensure the stopping of the load during its insertion along direction X1.

In FIG. 1b, the load W, in particular the receptacle, is inserted between a pair of interfaces 1A, 1b, substantially by moving the load along X1 in a direction that is oriented from first end E1 towards second end E2 of interface 1. One will note that insertion of the load, in particular of the receptacle, is carried out from one face of the rack, at the side of the open first end E1, which is open in the sense that first end E1 is without any stopping means at this end. Stopping means B3, B4 at second E2 end are for safety, to ensure the stopping of the load.

It is notable that stopping means B3, B4 may comprise:
a first stop B3, formed by a tab of the metal sheet, protruding from connecting and centering portion 3 via a folding/bending line between first stop B3 and connecting and centering portion 3,
a second stop B4, formed by a tab of the metal sheet, protruding from support portion 4 via a folding/bending line extending between second stop B4 and the portion.

The folding/bending lines between first stop B3 and connecting and centering portion 3, or between second stop B4 and support portion 4, are typically oriented to be perpendicular to longitudinal direction X1 of interface 1.

The tab forming first stop B3 and the tab forming second stop B4 may have two tab portions which overlap, in particular an overlap in direction Y1 and in direction Z1. According to one advantageous embodiment, the two tabs forming the two stops B3 and B4 are secured to each other by at least one connection point securing the tabs to each other, typically obtained by welding, clinking (press-joining), or stapling. Such a connection point securing the tabs of the stops to each other stiffens mechanical interface 1.

According to one embodiment, first bearing portion 2 and/or second bearing portion 6 comprise several attachment tabs 7, configured to ensure the attachment of a metal section forming an upright having attachment openings along its height, by insertion of the attachment tab or tabs into one or more of the attachment openings of the metal section.

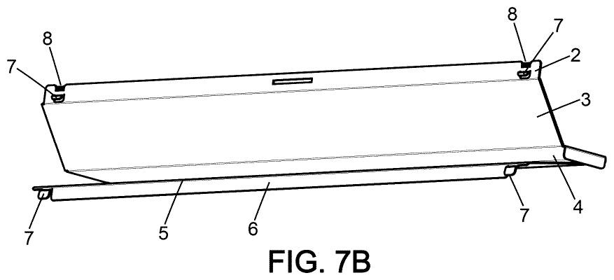

These tabs 7, typically made as one piece with the metal sheet, are oriented downwards, and are configured to hook into the attachment openings of the upright. Uprights M1, M2, M3, M4 thus can typically take the form of metal sections. Each interface 1, 1a, 1b, in particular right or left, may have two pairs of tabs, with a first pair of tabs 7 configured to hook into two attachment openings at two height levels in a first upright M1 (or M3) and a second pair of tabs 7 configured to hook into two attachment openings of a second upright M4 (or M5). The two tabs of each pair are respectively located on first bearing portion 2 and on second bearing portion 6, as can be seen in FIG. 7b as an indication.

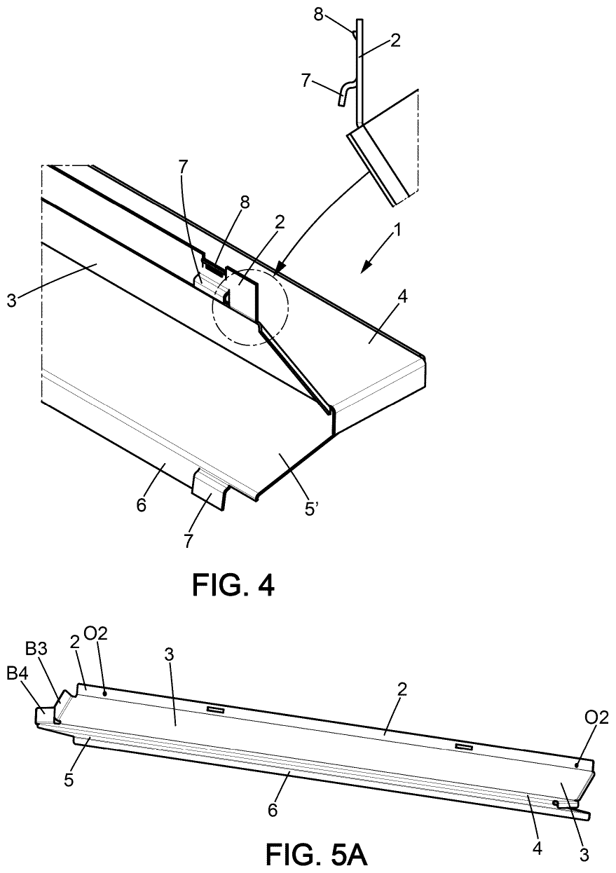

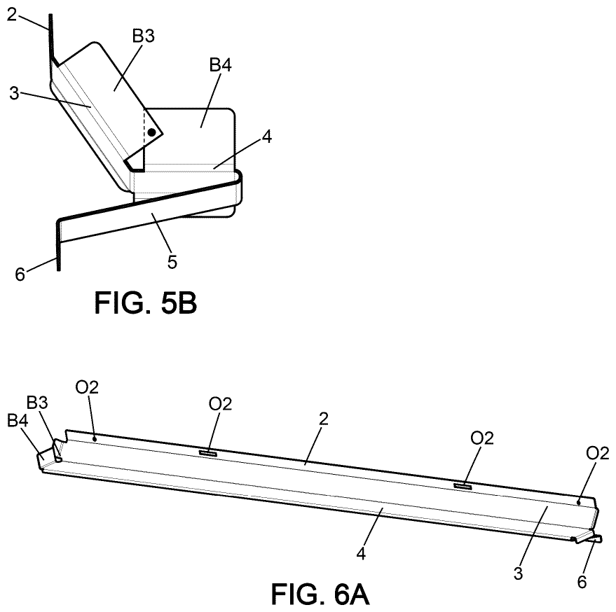

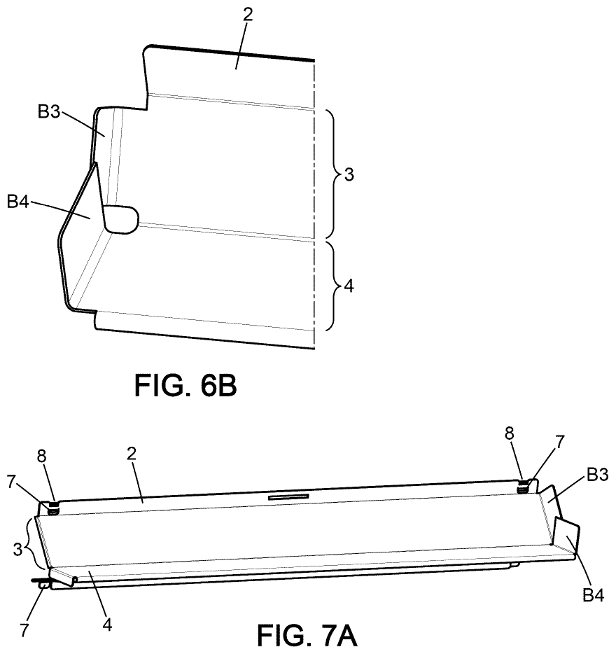

According to one embodiment, at least one of downward-oriented tabs 7 is configured to hook into an attachment opening and may advantageously be provided with a lift-prevention device comprising an elastic tooth 8, for example as can be seen in FIG. 4, configured to abut against an upper edge of the attachment opening, opposing the unhooking of attachment tab 7. Elastic tooth 8 may typically be formed as one piece with the metal sheet.

This disclosure further relates to a storage rack comprising:
a vertical structure comprising a set of vertical uprights M1, M2, M3, M4, typically in the form of vertical metal sections,
typically, a spacer system comprising one or more spacer devices distributed along the height of the vertical structure, mechanically interconnecting uprights M1, M2, M3, M4
one or more pairs of interfaces 1 according to this disclosure.

The or each pair of interfaces comprises:
a first interface 1A fixed by first bearing portion 2 and second bearing portion 6 to at least two uprights M1, M2 of the vertical structure,
a second interface 1B fixed by first bearing portion 2 and second bearing portion 6 to at least two other uprights M3, M4 of the vertical structure.

The two interfaces 1A and 1B, left and right, are oriented longitudinally along direction X1, and are typically symmetrical relative to one another in a central plane of symmetry between the two interfaces 1A and 1B.

Support portions 4 and connecting and centering portions 3 which are respectively part of first interface 1A and of second interface 1B are oriented towards one another and are configured to ensure the centering of a load W inserted and deposited between first interface 1A and second interface 1B by the effect of the connecting and centering portions 3 of the two interfaces 1A, 1B, and the supporting of a load W respectively supported by the two support portions 4 of the two interfaces 1a, 1b, on both sides of the load.

This disclosure further relates to a storage system for a warehouse, comprising receptacles and at least one storage rack according to this disclosure comprising several pairs of interfaces distributed along the height of the storage rack, and at least one transport system comprising one (or more) automated guided vehicle, the transport system being configured to grasp and deposit said receptacle in said storage rack.

Each receptacle is configured to be supported on both sides of the receptacle simultaneously and respectively by support portion 4 of first interface 1A and support portion 4 of second interface 1B.

Said automated guided vehicle may have means for locomotion and position identification in the storage system. In particular, it may have two-dimensional means for locomotion on a horizontal surface, and/or three-dimensional means of movement. According to the latter variant, said vehicle is then capable of moving vertically along the rack uprights.

To this end, the vertical structure of the storage rack, in particular at least one of the uprights, may comprise a toothed rack CR1, CR2 extending along the height of the vertical structure, or a taut chain extending along the height of the vertical structure.

The automated guided vehicle has a chassis, in particular carrying a mechanism for traveling across the floor, and climbing means comprising at least one cogwheel configured to mesh with toothed rack CR1, CR2 or with the links of the taut chain so as to enable the automated guided vehicle to climb up and down the vertical structure of the storage rack.

The automated guided vehicle comprises a deployable loading/unloading system configured for:
loading a receptacle from a retracted first position above the chassis to a deployed second position where the receptacle is centered and then supported by resting simultaneously on first interface 1A and second interface 1B, or
extracting a receptacle from the second position resting on first 1A interface and second interface 1B of a pair of interfaces 1A, 1B and loading it into the retracted first position.

The interface according to this disclosure, or the storage rack according to this disclosure, or the system for transporting loads W according to this disclosure, finds particular applications for a load comprising one or more receptacles held by a pair of mechanical interfaces supporting the bin or bins, up to 100 kg per supported receptacle, in particular under safety buffer conditions.

The load comprises a receptacle in the form of a receptacle weighing up to 34 kg per receptacle under operating conditions, and up to 100 kg per receptacle for a load with a safety buffer. The load with a safety buffer for interfaces holding two bins of dimensions 650 mm×450 mm, and of variable height, may therefore reach 200 kg in the event of filling with water following the triggering of an automatic sprinkling system.

It is understood that although the interface according to this disclosure has been described above largely in its application as a support for low loads (less than 100 kg per receptacle, in particular per bin), this disclosure is absolutely not limited to the supporting of light loads, but is also suitable for supporting heavier loads such as pallets, in that it also allows achieving substantial gains in mass.

### LIST OF REFERENCE SYMBOLS

1. Mechanical interface,
1a, 1b. First and second interface
2. First bearing portion
3. Connecting and centering portion,
4. Support portion,
40, 41. Proximal end and distal end respectively (of support portion),
5. Reinforcing portion,
6. Second bearing portion,
23. First folding/bending line,
34. Second folding/bending line,
45. Third folding/bending line,
56. Fourth folding/bending line,
7. Attachment tabs,
8. Elastic tooth (lift-prevention device),
FS. Support face (support portion 4),
FG. Guiding face (connecting and centering portion 5),
E1. First end (open),
E2. Second end (closed),
B3. Stop (connecting and centering portion),
B4. Stop (support portion)
M1, M2, M3, M4. Uprights,
ETR. Spacer device,
O2. Attachment openings.

1-26. (canceled)

27. A centering and support interface which is mechanical and is configured to be fixed so as to be laterally cantilevered from an upright of a rack in order to ensure the centering and supporting of a load on the rack, the upright or uprights extending in a vertical direction Z1, said interface comprising:
an upper first bearing portion, configured to bear against an upper portion of a vertical face of the upright, intended to ensure the attachment of the interface to the upright,
a lower second bearing portion, configured to bear against a lower portion of the vertical face of the upright,
a support portion, comprising an upper support face configured to ensure the supporting of the load, the support portion extending from a proximal end to a distal end while increasing the distance from first bearing portion and the second bearing portion,
a connecting and centering portion, connecting the first bearing portion and the proximal end of the support portion, having an upper guiding face which ensures the centering of the load towards the support portion by the movement of the load due to gravity,
a reinforcing portion, connecting the distal end of the support portion and the second bearing portion to form a reinforcing leg,
said interface comprising a body made as one piece, formed by a preformed metal sheet extending continuously so as to form successively, from top to bottom along the direction of the upright:
the first bearing portion,
the connecting and centering portion,
the support portion,
the reinforcing portion, and
the second bearing portion,
and wherein the first bearing portion, the connecting and centering portion, the support portion, the reinforcing portion, and the second bearing portion are respectively delimited by the mutually parallel folding/bending lines of the metal sheet, which are oriented along a longitudinal direction of the interface, comprising:
a first folding/bending line between the first bearing portion and the connecting and centering portion,
a second folding/bending line between the connecting and centering portion and the support portion,
a third folding/bending line between the support portion and the reinforcing portion,
a fourth folding/bending line between the reinforcing portion and the second bearing portion,
and wherein the first bearing portion and the second bearing portion are coplanar, extending in a plane X1Z1 that is parallel to the vertical face of the upright which the first bearing portion and the second bearing portion rest against at two positions on the upright which are offset along the vertical direction Z1 of the upright.

28. The centering and support interface according to claim 27, wherein said interface is made of metal, typically steel, and said interface has a linear density in a lengthwise direction that is less than or equal to 1.5 kg/m, in particular is between 0.8 kg/m and 1.3 kg/m.

29. The centering and support interface according to claim 27, consisting of said body made as one piece formed by a preformed metal sheet.

30. The centering and support interface according to claim 27, wherein the thickness of the metal sheet is less than or equal to 1.5 mm.

31. The centering and support interface according to claim 27, wherein the unfolded length of the sheet in a cross-section perpendicular to the folding/bending lines is between 170 mm and 210 mm.

32. The centering and support interface according to claim 27, wherein the first bearing portion and/or the second bearing portion comprise several attachment tabs configured to ensure the attachment of a metal section forming an upright having attachment openings, by insertion of the attachment tab or tabs into one or more of the attachment openings of the metal section.

33. The centering and support interface according to claim 32, wherein at least one of the tabs, oriented downwards, is configured to hook into an attachment opening and is provided with a lift-prevention device comprising an elastic tooth configured to come into abutment against an upper edge of the attachment opening, opposing an unhooking of the attachment tab.

34. The centering and support interface according to claim 27, wherein the first bearing portion and/or the second bearing portion comprises openings for attachment members such as rivets.

35. The centering and support interface according to claim 34, wherein the first bearing portion is double-skinned, obtained by folding the metal sheet onto itself, the attachment openings traversing the two skins.

36. The centering and support interface according to claim 27, consisting of the following five portions, in a cross-section viewed in a plane parallel to plane Y1Z1:
the first bearing portion,
the connecting and centering portion,
the support portion,
the reinforcing portion, and
the second bearing portion.

37. The centering and support interface according to claim 27, wherein the connecting and centering portion extends from the first bearing portion to the proximal end of the support portion, in a direction that is inclined relative to vertical direction Z1 at an angle A1 of between 25° and 45°, ensuring a downward inclination of the guiding face towards the support portion, and wherein the connecting and centering portion extends from the first bearing portion to the proximal end of the support portion, in a direction that is inclined relative to a horizontal direction Y1 at an angle A10 of between 45° and 65°, direction Y1 being perpendicular to the first bearing portion and to the second bearing portion,
and wherein the support portion extends from the proximal end to its distal end in a downward incline relative to a horizontal direction Y1 at a non-zero angle A2 of between 0° and 5°, direction Y1 being perpendicular to the first bearing portion and to the second bearing portion.
and wherein the reinforcing portion extends from the distal end of the support portion to the second bearing portion while drawing closer to the second bearing portion, and in a downward incline relative to a horizontal direction Y1 at an angle A3 of between 5° and 30°, direction Y1 being perpendicular to the first bearing portion and to the second bearing portion.

38. The centering and support interface according to claim 27, extending lengthwise in a horizontal direction X1 that is parallel to the first bearing portion and to the second bearing portion, comprising, along direction X1:
an open first end, configured to allow the insertion or extraction of a load by a movement of the load along direction X1,
a closed second end, comprising stopping means which protrude upwards from the connecting and centering portion and/or from the support portion and which are configured to stop the load during its insertion along direction X1.

39. The centering and support interface according to claim 38, wherein the stopping means comprise:
a first stop, formed by a tab of the metal sheet, protruding from the connecting and centering portion via a folding/bending line between the first stop and the connecting and centering portion,
a second stop, formed by a tab of the metal sheet, protruding from the support portion via a folding/bending line extending between the second stop and the portion,
and wherein the tab forming the first stop and the tab forming the second stop have two overlapping portions of the tabs which are secured to each other by at least one connection point securing the tabs to each other, typically obtained by welding, clinking (press-joining), or stapling.

40. The centering and support interface according to claim 27, wherein the second bearing portion extends between the fourth folding/bending line and a lower free edge of the preformed metal sheet, and wherein the first bearing portion extends between the first folding/bending line and an upper free edge of the preformed metal sheet.

41. The centering and support interface according to claim 27, wherein the first bearing portion and the second bearing portion extend outwards from the first folding line and from the fourth folding line respectively, in two opposite directions.

42. The centering and support interface according to claim 27, wherein the cross-section of the preformed metal sheet, in a plane perpendicular to the direction of the folding/bending lines, is an open cross-section.

43. A storage rack, comprising:
a vertical structure comprising a set of vertical uprights,
a spacer system comprising one or more spacer devices distributed along the height of the vertical structure, mechanically interconnecting the uprights
one or more pairs of centering and support interface interfaces according to claim 1, the pair of centering and support interface interfaces or each pair of centering and support interface interfaces comprising:
a first interface fixed by the first bearing portion and second bearing portion to at least two uprights of the vertical structure,
a second interface fixed by the first bearing portion and second bearing portion to at least two other uprights of the vertical structure,
and wherein the support portions and the connecting and centering portions respectively belonging to the first interface and to the second interface are oriented towards each other and are configured to ensure: the centering of a load inserted and deposited between the first interface and the second interface by the effect of the connecting and centering portions of the two interfaces, and the supporting of a load supported by the two support portions of the two interfaces on both sides of the load.

44. A storage system for a warehouse, comprising receptacles and at least one storage rack according to claim 43 comprising several pairs of interfaces distributed along the height of the storage rack, each receptacle configured to be supported on both sides of the receptacle simultaneously and respectively by the support portion of the first interface and by the support portion of the second interface.

45. The storage system according to claim 44, having a transport system comprising at least one automated guided vehicle, said transport system being configured for grasping and depositing receptacles in storage racks.

46. The storage system according to claim 45,
wherein the vertical structure of the storage rack, in particular at least one of the uprights, comprises a toothed rack extending along the height of the vertical structure, or a taut chain extending along the height of the vertical structure,
and wherein said at least one automated guided vehicle has a chassis, carrying a mechanism for traveling across a horizontal surface such as a floor, and climbing means comprising at least one cogwheel configured to mesh with the toothed rack or with the links of the taut chain so as to enable the automated guided vehicle to climb up and down the vertical structure of the storage rack, the automated guided vehicle comprising a deployable loading/unloading system configured for:
loading a receptacle from a retracted first position above the chassis to a deployed second position where the receptacle is centered and then supported by resting simultaneously on the first interface and second interface, or
extracting a receptacle from the second position resting on the first interface and second interface of a pair of interfaces and loading it into the first retracted position.
